(19) United States
(12) Patent Application Publication
(10) Pub. No.: US 2004/0067837 A1
(43) Pub. Date: Apr. 8, 2004

(54) Ceramic materials in powder form

(76) Inventors: Sabin Boily, Chambly (CA); Pascal Tessier, Montreal (CA); Houshang Alamdari, Sainte-Julie (CA)

Correspondence Address: FOLEY AND LARDNER, SUITE 500, 3000 K STREET NW, WASHINGTON, DC, 20007, US

(21) Appl. No.: 10/466,689

(22) PCT Filed: Jan. 18, 2002
(86) PCT No.: PCT/CA02/00070

(30) Foreign Application Priority Data
Jan. 19, 2001 (CA) 2,331,470

(51) Int. Cl. C04B 35/599

(52) U.S. Cl. 501/98.1; 501/98.2

(57) ABSTRACT

The invention relates to a ceramic material in powder form comprising particles having an average particle size of 0.1 to 30 μm and each formed of an agglomerate of grains with each grain comprising a nanocrystal of a ceramic material of formula (I): Si₃₋ₓAlₓO_{y}N_{z}, wherein 0≦x≦3, 0≦y≦6 and 0≦z≦4, with the proviso that when x is 0 or 3, y cannot be 0. The ceramic material in powder form according to the invention is suitable for use in the production of ceramic bodies by powder metallurgy, as well as in the formation of heat-resistant coatings by thermal deposition. The ceramic bodies and coatings obtained have improved resistance to thermal shocks.

### TECHNICAL FIELD

The present invention pertains to improvements in the field of ceramic materials. More particularly, the invention relates to ceramic materials in powder form for use in the formation of ceramic bodies and coatings having improved mechanical properties.

### BACKGROUND ART

All current methods of producing dense silicon and/or aluminum-based ceramic bodies are variations of a process wherein a mixture of powders is compacted and sintered at high temperature. Densification is usually achieved through the use of sintering aids which lead to the formation of a liquid phase between powder particles, thus ensuring densification. However, this usually weakens the material, since the liquid phase forms upon solidification a vitreous or crystalline phase having poor mechanical properties.

The current methods also produce coarse grains having typical dimensions of several microns, caused by the necessity to react raw materials and densify the ceramics at high temperatures. These coarse grains are detrimental to mechanical properties such as resistance to thermal shocks.

### DISCLOSURE OF THE INVENTION

It is therefore an object of the present invention to overcome the above drawback and to provide a ceramic material in powder form suitable for use in forming ceramic bodies and coatings having improved mechanical properties and, more particularly, improved resistance to thermal shocks.

According to one aspect of the invention, there is provided a ceramic material in powder form comprising particles having an average particle size of 0.1 to 30 μm and each formed of an agglomerate of grains with each grain comprising a nanocrystal of a ceramic material of the formula:

Si₃₋ₓAlₓO_{y}N_{z} (I)

wherein 0≦x≦3, 0≦y≦6 and 0<z≦4, with the proviso that when x is 0 or 3, y cannot be 0.

The term “nanocrystal” as used herein refers to a crystal having a size of 100 nanometers or less. The nanocrystalline microstructure considerably favors densification, even without sintering aids, when the ceramic material in powder form according to the invention is compacted and sintered to produce dense ceramic bodies. Nanocrystalline powders also minimize grain growth.

The present invention also provides, in another aspect thereof, a process for producing a ceramic material in powder form as defined above. The process of the invention comprises the steps of:

a) providing at least two reagents comprising as a whole at least three elements selected from the group consisting of silicon, aluminum, oxygen and nitrogen; and

b) subjecting the reagents to high-energy ball milling to cause solid state reaction therebetween and formation of particles having an average particle size of 0.1 to 30 μm, each particle being formed of an agglomerate of grains with each grain comprising a nanocrystal of a ceramic material of formula (I) defined above.

The expression “high-energy ball milling” as used herein refers to a ball milling process capable of forming the aforesaid particles comprising nanocrystalline grains of the ceramic material of formula (I), within a period of time of about 40 hours.

Modes for Carrying out the Invention

Examples of ceramic material of the formule (I) include Si_{2.8}Al_{0.2}O_{0.3}N_{3.7} and Si_{1.5}Al_{1.5}O_{2.5}N_{1.5}.

Examples of suitable reagents which may be used in the process according to the invention include silicon, aluminum, aluminum silicide as well as oxides, nitrides and oxynitrides of silicon and/or aluminum. Si, SiO₂, Si₃N₄, Al, Al₂O₃ and AIN are particularly preferred.

According to a preferred embodiment, step (b) is carried out in a vibratory ball mill operated at a frequency of 8 to 25 Hz, preferably about 17 Hz. It is also possible to conduct step (b) in a rotary ball mill operated at a speed of 150 to 1500 r.p.m., preferably about 1000 r.p.m.

According to another preferred embodiment, step (b) is carried out under an inert gas atmosphere such as a gas atmosphere comprising argon or helium, or under a reactive gas atmosphere such as a gas atmosphere comprising hydrogen, nitrogen, ammonia, carbon monoxide, carbon dioxide, silicon tetrahydride, silicon tetrachloride or water vapor. An atmosphere of argon, helium or hydrogen is preferred. It is also possible to carry our step (b) in the presence of a liquid such as a hydrocarbon (e.g. butane), acetone, methanol, ethanol, isopropanol, toluene or water, or a greasy substance such as stearic acid, to prevent the particles from adhering to one another.

Additives can be added during step (b) in order to improve the mechanical properties (e.g. flexural strength and hardness) of the ceramic bodies and/or coatings eventually made from the ceramics powder of the invention, to reduce their wettability by molten metals or alloys and/or to reduce their chemical reactivity (e.g. oxidation) with the environment. Examples of suitable additives include those comprising at least one element selected from the group consisting of B, C, Mg, Sc, Ti, V, Cr, Mn, Fe, Co, Ni, Cu, Zn, Se, Rb, Sr, Y, Zr, Nb, Mo, Rh, Cd, Te, Ba, La, Ce, Pr, Nd, Sm, Eu, Gd, Th, Dy, Ho, Er, Tm, Yb, Lu, Hf, Ta, Os, Ir and Tl. Boron and carbon are preferred.

The ceramic material in powder form according to the invention can be used to produce dense bodies by powder metallurgy. The expression “powder metallurgy” as used herein refers to a technique in which the bulk powders are transformed into preforms of a desired shape by compaction or shaping followed by a sintering step. Compaction refers to techniques where pressure is applied to the powder, as, for example, cold uniaxial pressing, cold isostatic pressing or hot isostatic pressing. Shaping refers to techniques executed without the application of external pressure such as powder filling or slurry casting. The dense bodies thus obtained can be used as structural parts, electronic substrates and other ceramic products.

The ceramic material in powder form according to the invention can also be used in thermal deposition applications. The expression “thermal deposition” as used herein refers to a technique in which powder particles are injected in a torch and sprayed on a substrate to form thereon a heat-resistant coating. The particles acquire a high velocity and are partially or totally melted during the flight path. The coating is built by the solidification of the droplets on the substrate surface. Examples of such techniques include plasma spray, arc spray and high velocity oxy-fuel.

The following non-limiting examples illustrate the invention.

### EXAMPLE 1

A Si_{2.8}Al_{0.2}O_{0.3}N_{3.7} powder was produced by ball milling 3.71 g of Si₃N₄ and 0.29 g of Al₂O₃ in a tungsten carbide crucible with a ball-to-powder mass ratio of 8.1 using a SPEX 8000 (trademark) vibratory ball mill operated at a frequency of about 17 Hz. The operation was performed under a controlled argon atmosphere. The crucible was closed and sealed with a rubber O-ring. After 20 hours of high-energy ball milling, a Si_{2.8}Al_{0.2}O_{0.3}N_{3.7} nanocrystalline structure was formed. The particle size varied between 0.1 and 5 μm and the crystallite size, measured by X-ray diffraction, was about 30 nm. The ceramic powder thus obtained was sintered without sintering aids to produce a dense body having improved resistance to thermal shocks.

### EXAMPLE 2

Si_{1.5}Al_{1.5}O_{2.5}N_{1.5} powder was produced by ball milling 0.523 g of SiO₂, 0.05 g of Si and 0.428 g of AlN in a silicon nitride vial with two 1/2 inch silicon nitride balls. The vial was sealed and placed in a SPEX 8000 vibratory ball mill operated at 17 Hz for 20 hours. The ceramic powder thus obtained was sintered without using any additive to produce a dense body.

### EXAMPLE 3

Si_{2.8}Al_{0.2}O_{0.3}N_{3.7} powder was produced by ball milling 1855 g of Si₃N₄ and 0.145 g of Al₂O₃ in a silicon nitride vial with two ½ inch silicon nitride balls. 0.05 g of boron was added to the mixture prior to milling. The vial was sealed and placed in a SPEX 8000 vibratory ball mill operated at 17 Hz for 20 hours. The ceramic powder thus obtained was sintered to produce a dense body that showed improved thermal shock resistance.

1. A ceramic material in powder form comprising particles having an average particle size of 0.1 to 30 μm and each formed of an agglomerate of grains with each grain comprising a nanocrystal of a ceramic material of the formula:
Si₃₋ₓAlₓO_{y}N_{z} (I)
wherein 0≦x≦3, 0≦y≦6 and 0<z≦4, with the proviso that when x is 0 or 3, y cannot be 0.

2. A ceramic material in powder form according to claim 1, wherein x is 0.2, y is 0.3 and z is 3.7.

3. A ceramic material in powder form according to claim 1, wherein x is 1.5, y is 2.5 and z is 1.5.

4. A ceramic material in powder form according to claim 1, further including at least one additive comprising at least one element selected from the group consisting of B, C, Mg, Sc, Ti, V, Cr, Mn, Fe, Co, Ni, Cu, Zn, Se, Rb, Sr, Y, Zr, Nb, Mo, Rh, Cd, Te, Ba, La, Ce, Pr, Nd, Sm, Eu, Gd, Th, Dy, Ho, Er, Tm, Yb, Lu, Hf, Ta, Os, Ir and Tl.

5. A ceramic material in powder form according to claim 4, wherein said additive is boron or carbon.

6. A ceramic material in powder form according to claim 1, wherein said average particle size ranges from 0.1 to 5 μm.

7. A process for producing a ceramic material in powder form as defined in claim 1, comprising the steps of:
a) providing at least two reagents comprising as a whole at least three elements selected from the group consisting of silicon, aluminum, oxygen and nitrogen; and
b) subjecting said reagents to high-energy ball milling to cause solid state reaction therebetween and formation of particles having an average particle size of 0.1 to 30 μm, each particle being formed of an agglomerate of grains with each grain comprising a nanocrystal of a ceramic material of the formula (I) as defined in claim 1.

8. A process according to claim 7, wherein said reagents are selected from the group consisting of silicon, aluminum silicide and oxides, nitrides and oxynitrides of silicon and aluminum.

9. A process according to claim 8, wherein said reagents are selected from the group consisting of Si, SiO₂, Si₃N₄, Al, Al₂O₃ and AlN.

10. A process according to claim 7, wherein step (b) is carried out in a vibratory ball mill operated at a frequency of 8 to 25 Hz.

11. A process according to claim 10, wherein said vibratory ball mill is operated at a frequency of about 17 Hz.

12. A process according to claim 7, wherein step (b) is carried out in a rotary ball mill operated at a speed of 150 to 1500 r.p.m.

13. A process according to claim 12, wherein said rotary ball mill is operated at a speed of about 1000 r.p.m.

14. A process according to claim 7, wherein step (b) is carried out under an inert gas atmosphere.

15. A process according to claim 14, wherein said inert gas atmosphere comprises argon or helium.

16. A process according to claim 7, wherein step (b) is carried out under a reactive gas atmosphere.

17. A process according to claim 16, wherein said reactive gas atmosphere comprises hydrogen, nitrogen, ammonia, carbon monoxide, carbon dioxide, silicon tetrahydride, silicon tetrachloride or water vapor.

18. A process according to claim 7, wherein step (b) is carried out in the presence of a liquid or a greasy substance.

19. A process according to claim 18, wherein said liquid is selected from the group consisting of butane, acetone, methanol, ethanol, isopropanol, toluene and water.

20. A process according to claim 18, wherein said greasy substance is stearic acid.

21. A process according to claim 7, further including the step of admixing during step (b) at least one additive comprising at least one element selected from the group consisting of B, C, Mg, Sc, Ti, V, Cr, Mn, Fe, Co, Ni, Cu, Zn, Se, Rb, Sr, Y, Zr, Nb, Mo, Rh, Cd, Te, Ba, La, Ce, Pr, Nd, Sm, Eu, Gd, Th, Dy, Ho, Er, Tm, Yb, Lu, Hf, Ta, Os, Ir and Tl.

22. A process according to claim 21, wherein said additive is boron.

23. A process according to claim 21, wherein said additive is carbon.
